(19) United States
(12) Patent Application Publication
(10) Pub. No.: US 2025/0191036 A1
(43) Pub. Date: Jun. 12, 2025

(54) CUSTOMER AND SERVICE PROVIDER COMMUNICATION SYSTEM

(71) Applicant: Uchenna Macfitz Ugo-Alum, East Brunswick, NJ (US)

(72) Inventor: Uchenna Macfitz Ugo-Alum, East Brunswick, NJ (US)

(21) Appl. No.: 18/958,333

(22) Filed: Nov. 25, 2024

Related U.S. Application Data
(60) Provisional application No. 63/608,386, filed on Dec. 11, 2023.

(51) Int. Cl. G06Q 30/02

(52) U.S. Cl. CPC G06Q 30/0281

(57) ABSTRACT

A system includes a transceiver configured to receive customer inputs and customer requests from a customer device and service provider inputs from a plurality of service provider devices. The system also includes a processor communicatively coupled with the transceiver. The processor is configured to obtain the customer request from the customer device to perform a predefined task, via the transceiver. The processor is configured to identify a list of service providers based on the customer request, the customer inputs and the service provider input. The processor is configured to transmit the list of service providers to the customer device. The processor is configured to receive a selection of a service provider from the list of service providers from the customer device. The processor is configured to transmit a notification to a service provider device associated with the selected service provider.

### CROSS-REFERENCE TO RELATED APPLICATIONS

This application claims the benefit of priority of U.S. provisional application No. 63/608,386, filed Dec. 11, 2023, title “CUSTOMER AND SERVICE PROVIDER COMMUNICATION SYSTEM,” the entire contents of which are herein incorporated by reference.

### FIELD

The present disclosure generally to a customer and service provider communication system, and more particularly to a system and method that facilitates direct communication between a customer and a service provider.

### BACKGROUND

There are many tasks in everyday life that a person or group does not know how to do, is simply not skilled enough, or requires a staff or labor force to perform. For these tasks, the persons typically seek out the assistance of service provider(s) to perform a specific task and becomes a customer or an employer for that service provider. For example, the customer can need service providers such as electricians, plumbers, cleaners, photographers, interior designers, etc. to perform associated tasks in which the service providers have expertise. In some scenarios, the customer will not be aware of any service provider that can perform the task desired by the customer. In such scenarios, the customer can reach out to friends and family members for recommendations or perform searches on the Internet to find a service provider to perform the task. Typically, this approach of finding service providers is time-consuming, and do not yield effective results. In addition, the customer can find it difficult to determine if the identified or recommended service provider has the required skills and experience to perform the task properly.

Thus, there exists a need for a system that facilitates a user in effectively and conveniently finding a service provider for a specific task desired by the user. The present invention solves these issues by providing a system and method that facilitates direct communication between a customer and a service provider

### SUMMARY

In one aspect of the present disclosure, a system to facilitate communication between a customer and a service provider. The system includes a transceiver configured to receive customer inputs and customer requests from a customer device and service provider inputs from a plurality of service provider devices. The system also includes a processor communicatively coupled with the transceiver. The processor is configured to obtain the customer request from the customer device to perform a predefined task, via the transceiver. The processor is configured to identify a list of service providers based on the customer request, the customer inputs and the service provider input. The processor is configured to transmit the list of service providers to the customer device. The processor is configured to receive a selection of a service provider from the list of service providers from the customer device. The processor is configured to transmit a notification to a service provider device associated with the selected service provider to facilitate communication between the customer associated with the customer device and the service provider associated with the service provider device.

### BRIEF DESCRIPTION OF THE DRAWINGS

FIG. 1 shows a schematic diagram of an exemplary environment in which the systems and methods of customer and service provider communication can be implemented, according to aspects of the present disclosure.

FIG. 2 shows a system to facilitate interaction between three user devices on a platform, according to aspects of the present disclosure.

FIG. 3 shows an exemplary network of user interactions within the system, according to aspects of the present disclosure.

FIGS. 4A and 4B show how organizations can use a platform in accordance to onboard and coordinate assignments among employees or contractors, according to aspects of the present disclosure.

FIGS. 5A-5D show how employees, workers, or contractors can be scheduled, assigned to various tasks, and prioritized for new projects on a platform, according to aspects of the present disclosure.

FIG. 6 shows how scheduling can occur and be displayed on a platform, according to aspects of the present disclosure.

FIG. 7 shows how auto-scheduling can occur on a platform, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Broadly, an embodiment of the present disclosure provides a system to facilitate connection, communication and coordination between a customer (e.g., individual user or an industry employer) and a service provider (e.g., independent enterprise or industry worker) to achieve finding, hiring, staffing and scheduling objectives within a mutually shared environment of interests and needs. The system facilitates a communication network of service-seeking customers and professionally eligible service providers, whereby each user, depending on the services needed or the area of expertise, can operate the platform as either a customer or a service provider or both. The system includes a transceiver and a processor. The transceiver can receive customer inputs and customer requests from a customer device, and service provider inputs from a plurality of service provider devices. The processor can obtain the customer request from the transceiver. In some embodiments, the customer request is to perform a predefined task. Upon receiving the customer request, the processor can identify a list of service providers based on the customer request, the customer inputs, the service provider inputs, and a shared geographical location or interest-physical or virtual-between the customer and service provider. The processor can further transmit the list of service providers to the customer device and receive a selection of one or more service providers from the list of service providers from the customer device. The processor can then transmit a notification to the service provider device(s) associated with the selected service provider(s) to facilitate communication between the customer associated with the customer device and the service provider(s) associated with the service provider device(s).

In another scenario, a service provider can find it challenging and even costly to find reliable leads or acquire customers in real-time. The present disclosure facilitates reducing lead generation time to generate leads for the service providers. In addition, the present disclosure facilitates interaction, communication, and transaction between the customer and the service providers. Further, the platform enables the customer to select service providers from a list of service providers to perform the desired task.

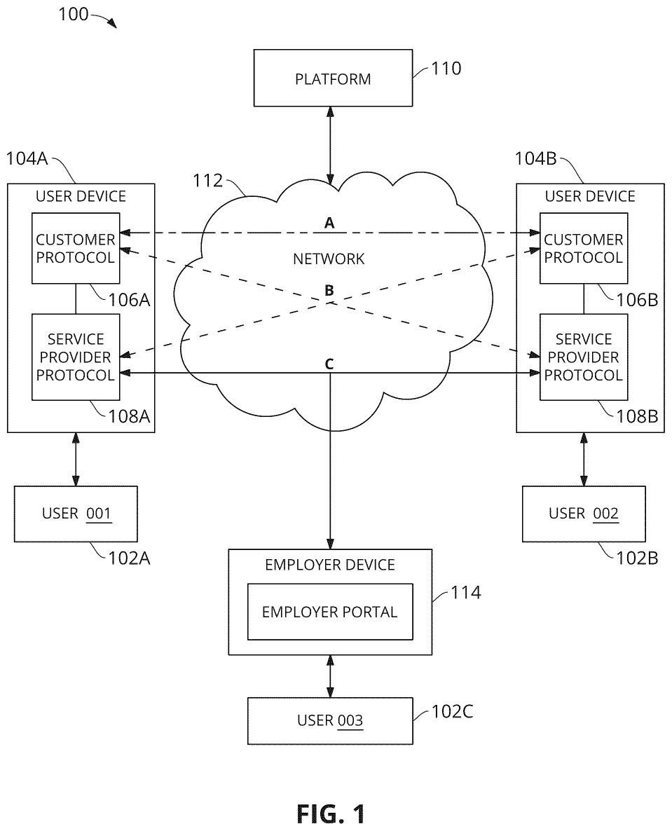

Referring now to FIGS. 1-3, 4A, 4B, 5A-5D, 6, and 7, FIG. 1 illustrates an exemplary environment 100, according to aspects of the present disclosure. While FIG. 1 illustrates examples of components of the environment 100, additional components can be added and existing components can be removed and/or modified.

The environment 100 can include (i) a user 001 interacting with the platform as customer 102A (or a “taskee”) or as service provider 102A (or a “tasker”), (ii) a user 002 interacting with the platform as service provider 102B (or a “tasker”) or customer 102B (or a “taskee”) of a plurality of service providers, and (iii) user 003 interacting with the platform as an employer 102C. A user 001 can be associated with a user device 104A; a user 002 can be associated with a user device 104B; and a user 003 can be associated with an employer device 114. The plurality of service providers—skilled and certified workers and businesses-can provide numerous services under any number of different industries, including, Volunteerism, Philanthropy, Building & Construction, Home Improvement, Environmental, Real Estate, Accounting & Finance, Entertainment, Wellness & Health care, Education, Fitness, Food & Hospitality, etc. The customer 102A can be associated with a customer protocol 106A and the service provider 102A can be associated with a service provider protocol 108A; the service provider 102B can be associated with a service provider protocol 106B and the customer 102B can be associated with a customer protocol 108B; and the employer 102C can be associated with a employer device 114.

The user device 104A and the user device 104B can include, but are not limited to, mobile devices, tablets, laptops, wearable or any such devices having electronic communication capabilities. The employer device 114 can include, but is not limited to, mobile devices, tablets, laptops, desktop, wearable or any such devices having electronic communication capabilities. The user device 104A, the user device 104 and the employer device 114 can be communicatively coupled to a platform 110 via a network 112.

In some embodiments, the platform 110 can be hosted on at least one server and can be configured to facilitate direct communication or interaction between the customer 102A and the service provider 104A, via respective protocols 106A, 108B. In some embodiments, the platform 110 can enable the customer 102A and the service provider 102B to perform one or more functions via the customer protocol 106A or the service provider protocol 108B, respectively. For example, the platform 110 can enable the customer 102A to view, via the customer protocol 106A, a list of service providers who can perform a predefined task desired by the customer 102A, select one or more service providers from the list of service providers, generate task(s) and events/job, chat sessions with service providers, and process payment, among other functions.

In some embodiments, the platform 110 can enable both user 001 and user 002 interacting on the platform each as a customer whereby user 001 can provide voluntary services to user 002—as with friends and family or a formal volunteer—and vice versa. For example, the customer 102A can select a list of one or more contacts from the customer's phone list and can transmit details of the tasks/events to the list of contacts. The selected contacts can or cannot be the selected service providers 102B who can perform the required tasks. For example, the selected contacts can be a known person to the customer 102A, such as friends and family members. In further embodiments, the user 001 and user 002 if professionally eligible, can boost (add to) their user status by selecting their service provider category on the platform 110. In addition, user 001 and user 002 can indicate volunteer tasks that they can perform or volunteer tasks that they can require be performed on their behalf. For example, user 002 (interacting with the platform as customer 102B) as with user 001 (interacting with the platform as customer 102A) can select one or more volunteer task interests from a predefined list while creating their respective profiles. The platform 110 can then receive a request from user 001 (customer 102A) on customer protocol 106A and transmits the details of the volunteer task via customer protocol 106B to selected users 002 (customers' 102B) who are users' 001 shortlist of personal contacts (friends and family) located for instance, on user device 104A contact list.

In embodiments, the platform 110 can include a processing device coupled to a communication device. The processing device can also coupled to a memory device. The processing device, the communication device, and the memory device, can be interconnected via a system bus. The system bus can be and/or include a control bus, a data bus, an address bus, and the like. The processing device can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device

The memory device can be and/or include one or more computerized storage media capable of storing electronic data temporarily, semi-permanently, or permanently. The memory device can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 108.

The communication device enables the platform 110 to communicate with other devices and systems. The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

In embodiments, the components and functionality of the platform can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the platform can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

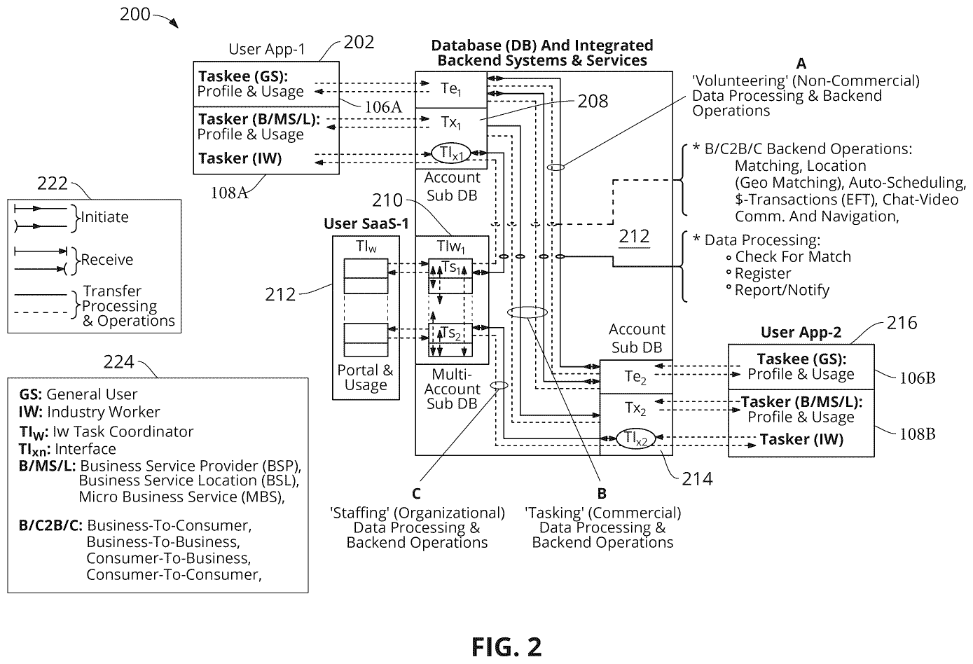

FIG. 2 depicts an example 200 communications brokered by the platform 110 to facilitate interaction between three user devices (e.g., the user device 104A, the user device 104B, and the employer device 114) with the platform 110, in accordance with an embodiment of the present disclose. The example 200 can include the platform 110 (e.g., database and integrated backend systems and service) and the user device 104A running a user app-1 202, the user device 104B running a user app-2 216, and the employer device 114 utlixing user Saas-1 212. The platform 110 can include one or more transceivers embedded or integrated with the network 212 (shown as systems Te1/Te2, Te1/Tx2, Te2/Tx1, Ts2/Tlx2 and Ts1/Tlx1), as depicted in FIG. 2. The transceiver can be configured to receive information from the customer protocols 106A and 106B, the service provider protocols 108A and 108B, and the employer portal. In some embodiments, the platform 110 can receive requests from the customer 102A and from the service provider 102B, and can perform data processing on the information received from the customer 102A and the service provider 102B via a processor (not shown) of the platform 110. The data processing can include matching, reporting, registering, and/or the like, as described above. For example, the processing can include processes 208, 210, 214, 222, and 224, as illustrated in FIG. 2. In some embodiments, the data processing can include processing for commercial and non-commercial tasks (e.g., volunteer tasks).

Specifically, the processor can obtain a request from the customer 102A to perform a predefined task. Based on the request, the processor can identify a list of service providers 102B and transmit the list of service providers to the customer 102A. The processor can then receive a selection of a service provider 102B from the list of service providers from the customer 102A and transmit a notification to a selected service provider 104 to perform the predefined task.

In some embodiments, the platform 110 can receive requests from an employer portal 116 and a service provider portal 108B and/or 108 and can perform data processing on the information received from the customer 102A and the service provider 102B via a processor (not shown) of the platform 110. The data processing can include matching, reporting, registering, and/or the like, as described above. In some embodiments, for example, the data processing can include processing for shift staffing and scheduling.

As depicted in FIG. 2, all three user device 104A, the user device 104 and the employer device 114 can be configured to exchange information on the platform 110 via the network 212. Each of the users can be assigned different roles in the system, e.g., administrator, coordinator, and worker. The user can be arranged in a hierarchical structure for assigning roles in the system, and staff and schedule tasks. In some embodiments, the platform 110 can enable user 003 to interact with user 001 and/or user 002 as an employer 102C. For example, employer 102C can hire and onboard service provider 102A and/or service provider 102B to perform organization-specific tasks. The employer 102C can further assign service provider 102A and/or service provider 102B to tasks at specific times via a scheduling function on the platform 110. The employer 102C can also prioritize tasks for service provider 102A and/or service provider 102B.

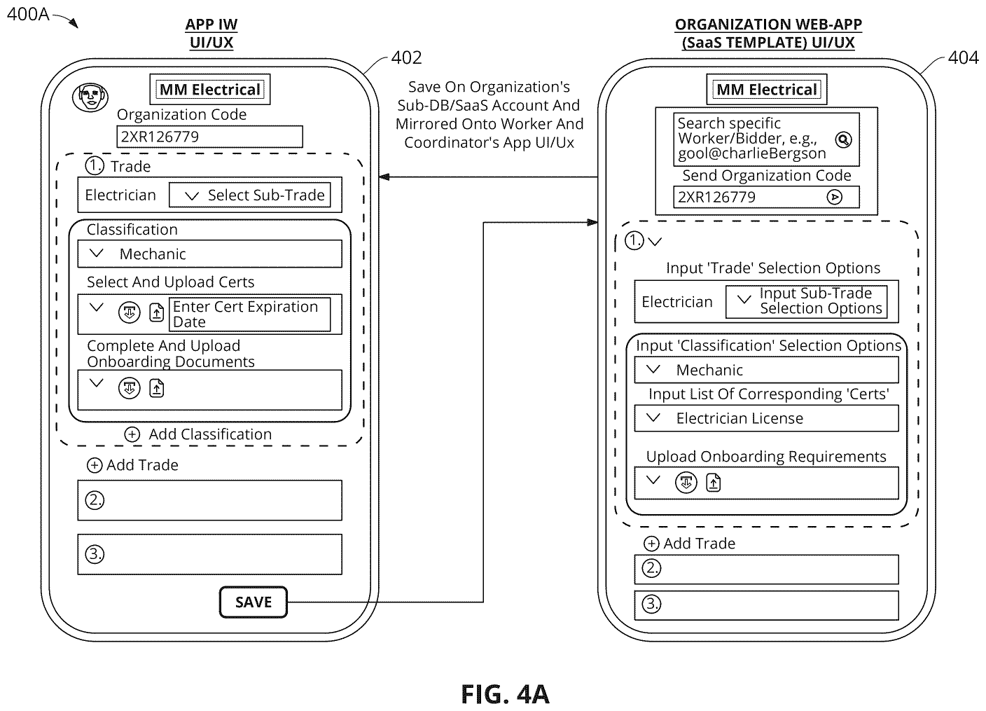

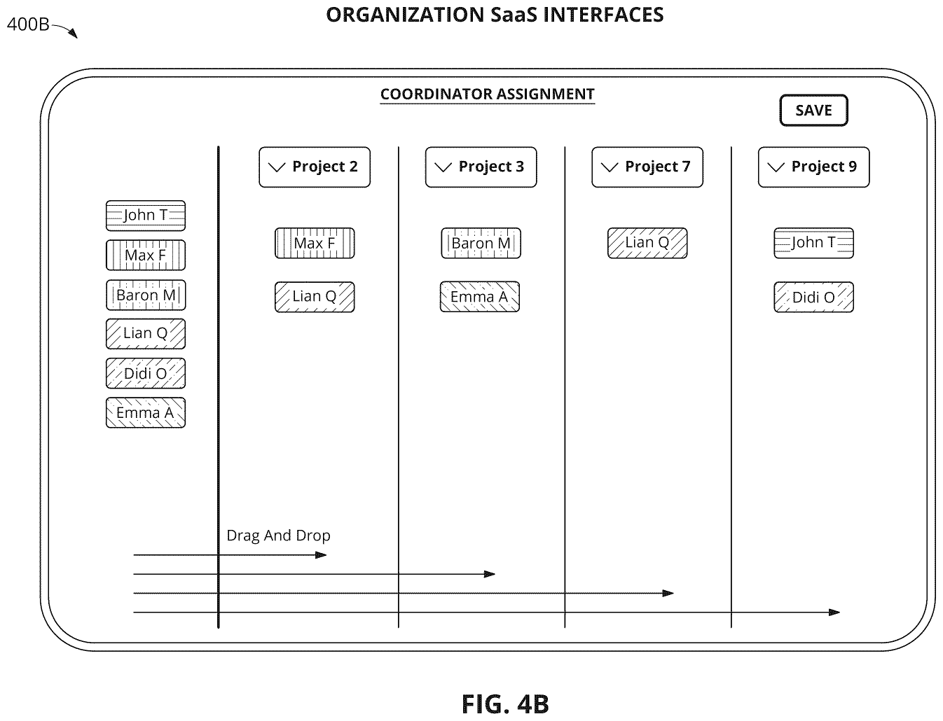

In embodiments, as illustrated in FIGS. 4A and 4B, in a process 400A, a user, e.g., service provider 102B, can enter their details in an interface 402 that is saved to the platform 110 and viewable view an interface 404. A user, e.g., a employer 102C, and then assign the service providers to different project using an interface 400B, for example, by dragging and dropping service provider 102B profiles.

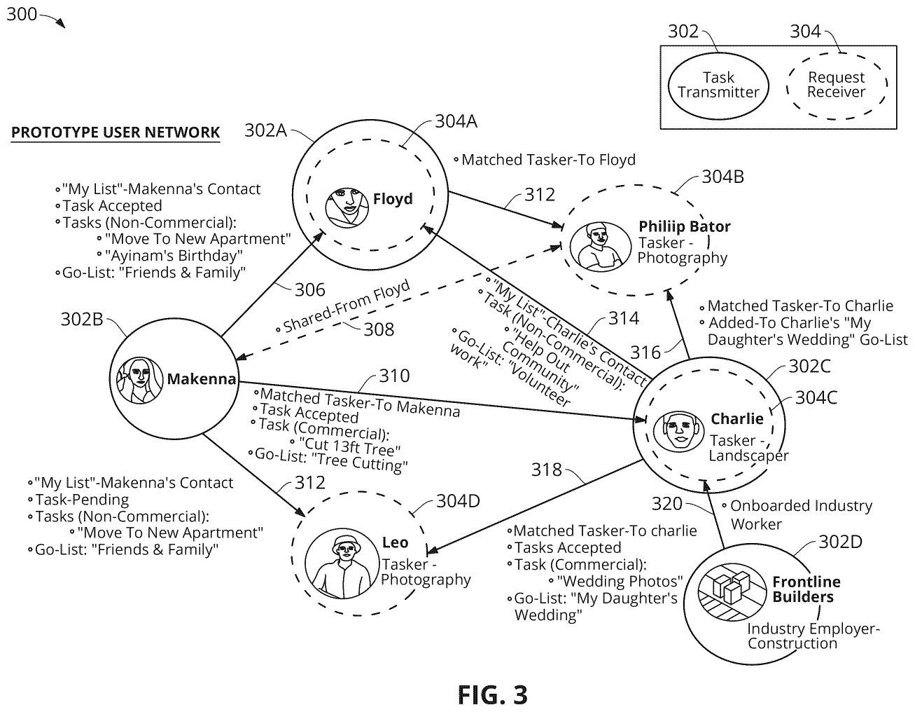

FIG. 3 depicts an exemplary network 300 of users in the platform 110. The network 600 can include a customers 302 (same as the customers 102A, service provider(s) 604 (same as the service provider 104), customer 302 (same as the customer 104) (e.g., selected contacts of the customer 102, as described above) and employer 302D (same as employer 102C). As depicted in FIG. 3, the customer 302 (e.g., 302B) can connect with any service provider 304 registered on the platform 110. Thus, the customer 302 can conveniently search for a service provider 304 to perform the required task and can transmit the request to the service provider 304 via the platform 110. The service provider 304 can also be referred to the customer 302 by a customer 304 (e.g., friends/family members list of customer 302B) directly through the platform 110.

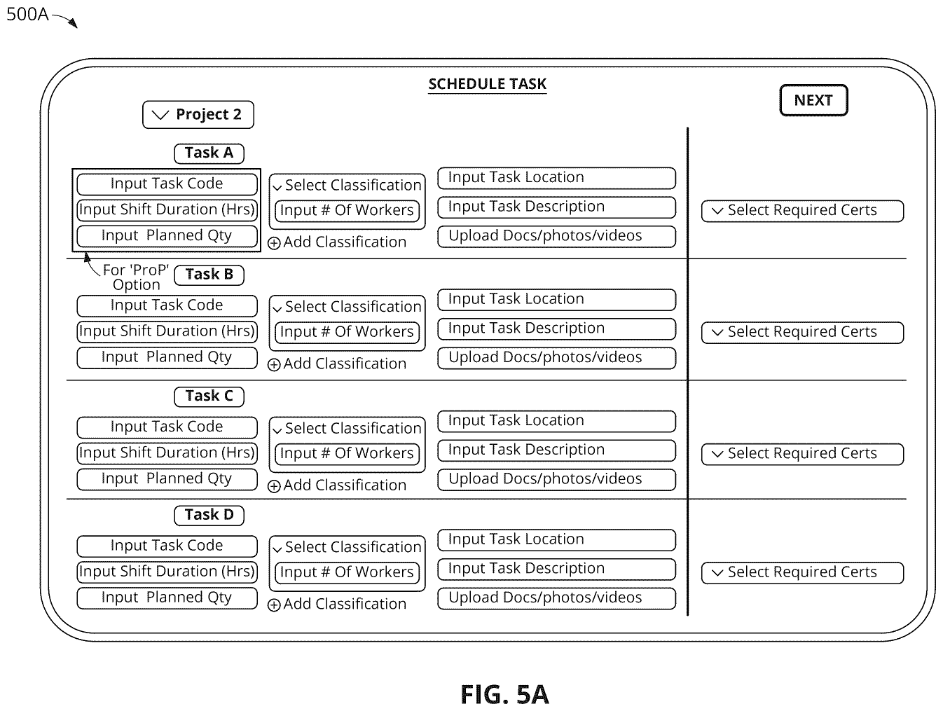

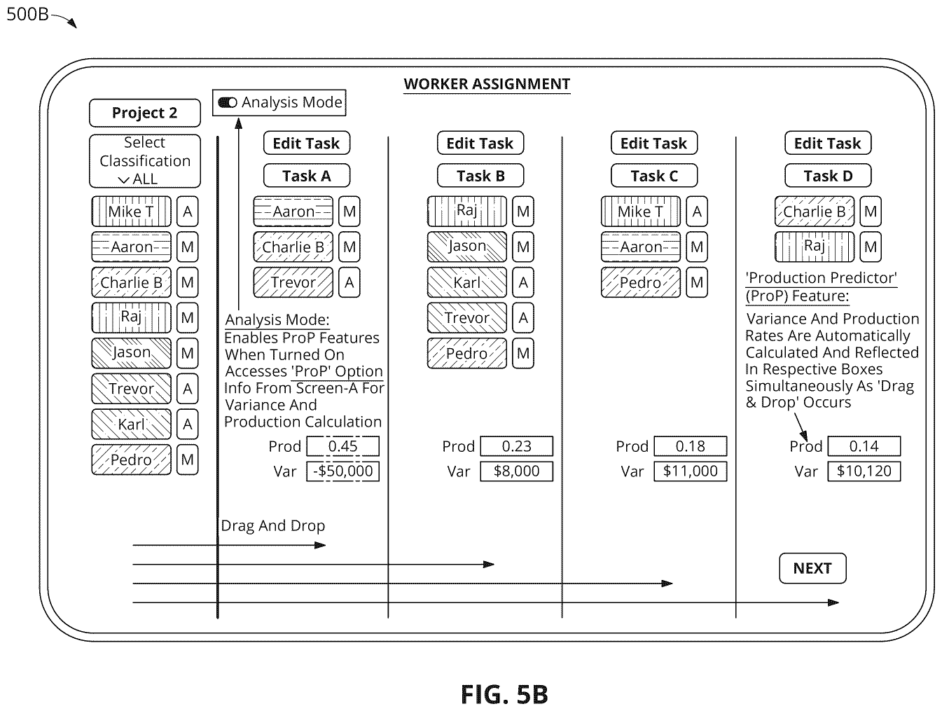

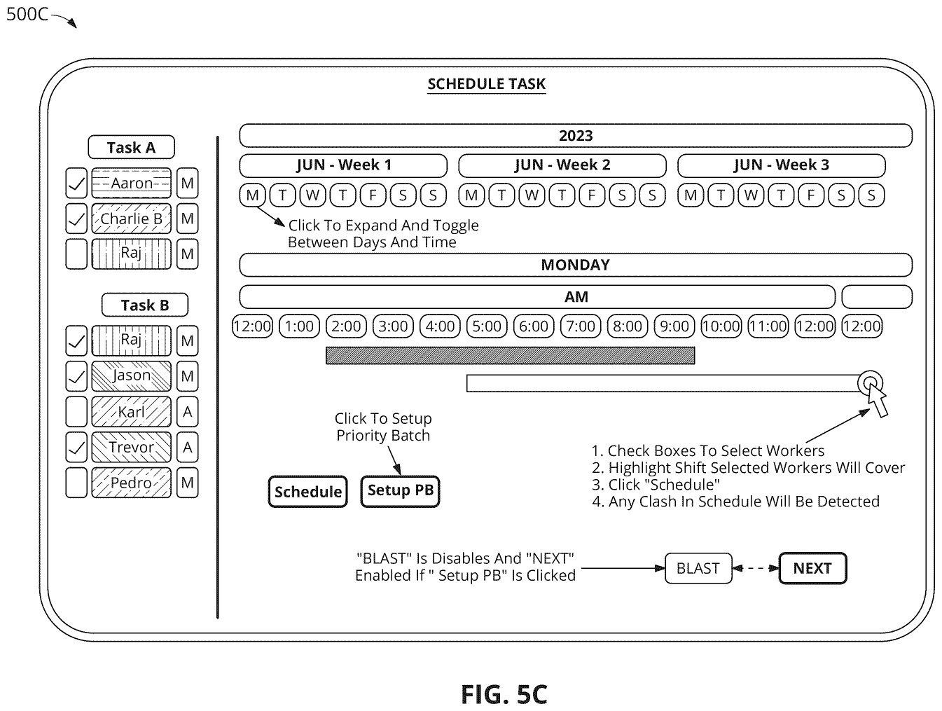

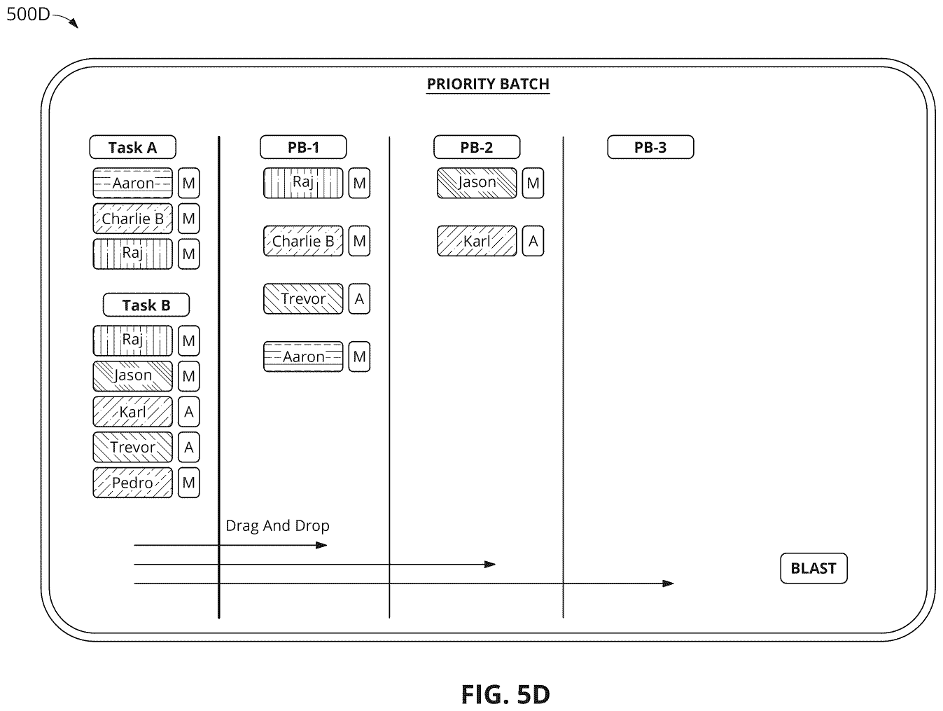

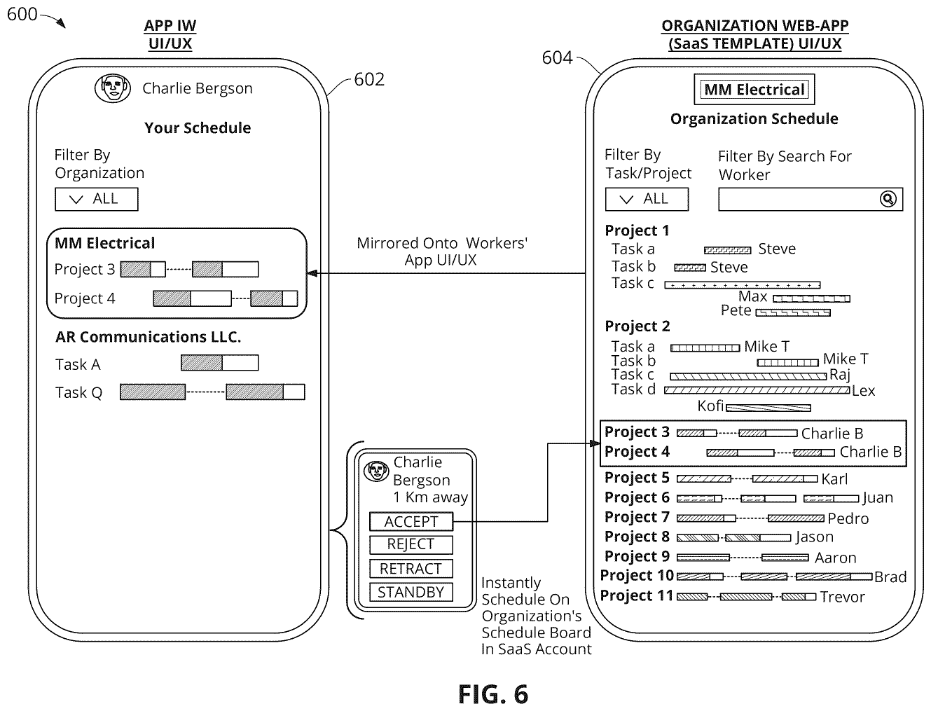

As described above, when the service provider 304 or customer 304 receives the request to perform the event/task desired by the customer 302, they can view the request on a service provider and customer protocols respectively and can accept or decline the request. For example, as illustrated in FIGS. 5A-5D, the employer 302D can schedule task for a worker and manage workers assigned to project. As illustrated in FIG. 6, the worker can view their schedule of assigned tasks.

Consider a task request to customers 302 (voluntary provision of service): If the number of taskers indicated by customer 302 for a particular task or event has been reached, all other customers 304 will be placed on standby until such time as one or more customers 304 retract their response, thereby making an opening available, and as such, the next customer 304 on standby then receives the opportunity to accept. When the customer 304 accepts the request, the customer 302 can directly interact with the customer 304 via a chat interface in the platform 110. In some embodiments, the customer 302 can transmit the request to the customer 304 via the chat interface. In further embodiments, the customer 302 can use the chat interface to transfer funds or make payments to one or more customers 304 based on pre-agreements between customer 602 and the respective customers 304.

Consider a task request to service provider 304 (commercial/professional service provider): If request for service by customer 302 for a particular task has been accepted, all other service providers 304 will be placed on standby until such time as one of the service providers 304 retract their response, thereby making an opening available, and as such, the next service provider 304 on standby then receives the opportunity to accept. When the service provider 304 accepts the request, the customer 302 can directly interact with the service provider 304 via a chat interface in the platform 110. In some embodiments, the customer 302 can transmit the request to the service provider 304 via the chat interface or can instruct the service provider 304 to proceed with the task. In further embodiments, the customer 302 can use the chat interface to receive invoices or any other information. Additionally, the chat interface can enable the customer 302 to pay invoices. For example, after the task is completed, the service provider 304 can send the invoice to the customer 302 via the chat interface, and the customer 302 can directly pay through the chat interface. After the payment is done, the task can be removed from the calendar (which can be added when the service provider 304 accepts the task) and added to transaction history.

In some embodiments, an employer 302D can connect with any service provider 304, or alternatively, any service provider 302 registered on the platform 110. For example, as illustrated in FIGS. 5A-5D, the employer 302D can schedule task for a worker and manage workers assigned to project. As illustrated in FIG. 6, the worker can view their schedule of assigned tasks.

In some embodiments, the customer 102A can register on the platform 110 to perform one or more functions as described above, via the user device 104A and customer protocol 106A. The registration can include creating a profile of the customer 102. To create a profile, the customer 102A can provide customer inputs. The customer inputs can include, but are not limited to, the customer's 102S name, email address, phone number, mailing address, and details of a task that the customer 102A can desire to be performed by a service provider. As part of the customer inputs, the customer 102A can select a task from a pre-defined list of tasks. Examples of the task can include, but are not limited to, landscaping, plumbing, electrical work, or interior decorating. In further embodiments, the customer inputs can include customer preferences such as specific requirements associated with the selected task, timing for completion of the task, and/or the like. In addition, the customer 102A can also indicate one or more volunteer tasks that the customer 102A can perform. For example, the customer 102A can select one or more volunteer tasks from a predefined list while creating the customer profile.

In embodiments, the service provider 104 can register on the platform 110 to provide details of respective services that the service provider 104 can perform, via user device 104 and the service provider protocol 108. The registration can include creating a profile of the customer 104. In certain embodiments, the user 002 can boost status by becoming a “tasker” (service provider 102B) and creating a service provider profile. To create the service provider profile, the service provider 102B can provide service provider inputs. The service provider inputs can include name and contact details of the service provider 102B. In addition, the service provider inputs can include the service provider “specialties”, which are service(s) that the service provider 102B can provide, such as plumbing, landscaping, or electrical work under the Home Improvement industry, and accomplishing this by selecting one or more service provider specialties from a pre-defined list of services. In some embodiments, the service provider inputs can include additional details related to the services the service provider 102B is able to provide, such as the service provider 102B, certificates, previous work experience, and examples of previously completed work (e.g., videos and/or images). In further embodiments, the service provider inputs can include service provider preferences. For example, the service provider 102B can provide preferences to work globally or locally. In case the service provider 102B prefers to work locally, the service provider 102B can select a geographical location or provide details of the state, city, country, zip code, etc. in which the service provider 102B can want to provide services.

In some embodiments, the employer 102C can register on the platform 110 via an employer 102C in order to hire and onboard service provider 102A and/or service provider 102B to perform organization-specific tasks. The employer 102C can further provide details of respective services that the employer 102C and associated service providers 102A and 102B can perform, via employer device 114 and the service provider protocol 108A/108B. The registration can include creating a profile of the service provider. In certain embodiments, the user 002 can boost status by becoming a “tasker” (service provider 102B) and creating a service provider profile. To create the service provider profile, the service provider 102B can provide service provider inputs. The service provider inputs can include name and contact details of the service provider 102B. In addition, the service provider inputs can include the service provider “specialties”, which are service(s) that the service provider 102B can provide, such as plumbing, landscaping, or electrical work under the Home Improvement industry, and accomplishing this by selecting one or more service provider specialties from a pre-defined list of services. In some embodiments, the service provider inputs can include additional details related to the services the service provider 102B is able to provide, such as the service provider's 102B, certificates, previous work experience, and examples of previously completed work (e.g., videos and/or images). In further embodiments, the service provider inputs can include service provider preferences. For example, the service provider 102B can provide preferences to work globally or locally. In case the service provider 102B prefers to work locally, the service provider 102B can select a geographical location or provide details of the state, city, country, zip code, etc. in which the service provider 102B can want to provide services.

In accordance with the present disclosure, the platform 110 can be configured to receive the customer inputs and the service provider inputs from user device 104A/104B via the customer protocol 106 and the service provider protocol 106A respectively, and the service provider protocol 108A and the customer protocol 106B and the service provider protocol 108B alternatively. In some embodiments, the platform 110 can receive the customer inputs and the service provider inputs when the customer 102A and/or the service provider 102B register (or create a profile) on the platform 110. Upon receiving the customer inputs and the service provider inputs, the platform 110 can perform data processing on the customer inputs and the service provider inputs.

In some embodiments, the data processing can include matching the customer 102A based on the details of the task provided by the customer 102A with one or more of the service providers 102B. The matching can also be performed based on the customer inputs and the service provider inputs. For example, the platform 110 can match the customer 102A and the service provider 102B based on a task selected by the customer 102A and a service selected by the service provider 102B. In some embodiments, the matching can further be performed based on the customer's 102A and service provider's 102B preferences. For example, the matching can be based on a service provider's 102B preference to work globally or locally. Alternatively, the platform 110 can enable the customer 102A to search for appropriate service providers 102B in place of or in addition to the matching provided by the platform 110.

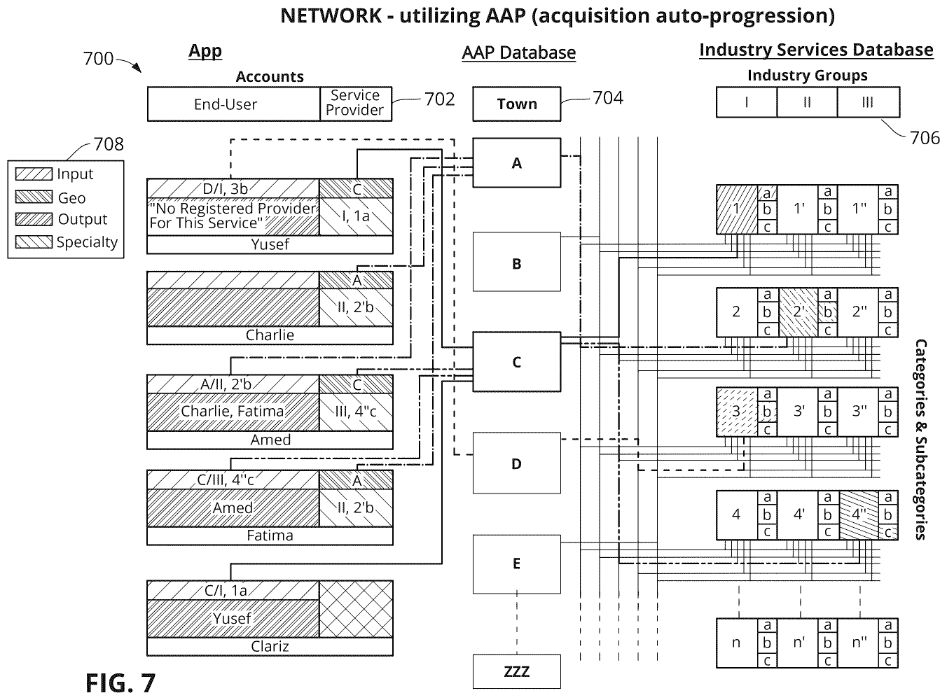

As illustrated in FIG. 7, the platform 110 can maintain a record 700, the customer/service provider accounts such that it includes information about the customer/service. As illustrated, the record 700 can maintain information such as service provider details 702, geographic location 704, and industry group 706 including indicia 708 for categorizing the records 700. The records 700 can be used to match, relate, and classify the customers and service providers.

After matching the customer 102A with the service provider 102B, the platform 110 can transmit notifications to the customer 102A and the service provider 102B to indicate a match has been made through the customer protocol 106 and the service provider protocol 108. For example, the platform 110 can transmit a notification to the customer protocol 106A, which can include a list of service providers that can perform the required task desired by the customer 102A. The customer protocol 106A can receive the notification and display the list of service providers on the user interface of the customer protocol 106A. Similarly, the platform 110 can transmit a notification to the service provider protocol 108B that can include a list of customers (e.g., potential customers) that can be interested in availing services provided by the service provider 102B. The service provider protocol 108B can receive the notification and display the list of customers on the user interface of the service provider protocol 108B.

In accordance with further embodiments of the present invention, the platform 110 can enable the customer 102A to select one or more service providers from the list of service providers shown on the user interface of the customer protocol 106. In some embodiments, the customer 102A can view a service provider's specialty, certificates, previous work details, etc. on the platform 110 and can shortlist one or more service providers 102B based on the customer's requirements and preferences. The customer 102A can transmit a request to the platform 110 (via the customer protocol 106A) to connect with the shortlisted service providers 102B. The request can include a list of shortlisted service providers 102B. The platform 110 can receive the request from the customer protocol 106A, and transmit notifications associated with the request to the service provider protocols 108B associated with the shortlisted service providers 102B.

In an exemplary embodiment, the customer 102A can generate one or more tasks that the customer 102A can want to complete via a voluntary service provisioned by customer 102B (family or friend/personal contact) or by a service provider 102B (commercial/professional service provider) and can transmit the request having details of the tasks to the platform 110. Specifically, the customer 102A can create a task by providing task name or type, task location, task date, time slot in which the customer 102A desires the task to be completed, number of taskers needed, etc. The platform 110 can receive the details of the task and transmit the details of the task to the list of shortlisted customers 102B or service provider 102B according to the category of request-voluntary/family & friends/personal contact or commercial/professional.

In further embodiments, the customer 102A can create an event (a task that has multiple co-dependent sub-tasks within the same objective). In this embodiment, events can be associated with only voluntary services provisioned by customer 102B for customer 102A or alternatively, customer 102A for customer 102B. The customer 102A can create an event by providing details of each sub-task, including, but not limited to, the name of each event, event location, event type, event date or time slot, specific requirement, taskers/service providers required for each event, etc. For example, the customer 102A can create an event (e.g., a main task) entitled “birthday”, and can create sub-tasks under the “birthday” main task and transmit the details of the sub-tasks to the platform 110. The sub-tasks for the “birthday” main task can be to bring drinks, pick up a DJ, pick a cake, etc.

A customer 102B present in the list of shortlisted service providers can receive the request from the customer 102A, via the platform 110. The customer 102A can view the event assigned to the customer 102B, and information associated with the event on the customer protocol 106B and can accept or decline to perform the event or allocated sub-tasks.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which can be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that can include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A system to facilitate geographical and specialistic auto-locating and communication between a customer and a service provider, the system comprising:
a transceiver configured to receive customer inputs and customer requests from a customer device and service provider inputs from a plurality of service provider devices; and
a processor communicatively coupled with the transceiver, wherein the processor is configured to:
obtain the customer request from the customer device to perform a predefined task, via the transceiver;
identify a list of service providers based on the customer request, the customer inputs, and the service provider inputs;
transmit the list of service providers to the customer device;
receive a selection of a service provider from the list of service providers from the customer device; and
transmit a notification to a service provider device associated with the selected service provider to facilitate communication between the customer associated with the customer device and the service provider associated with the service provider device.

2. The system of claim 1, wherein the list of service providers includes at least one other customer providing services as a service provider.

3. The system of claim 1, wherein identifying a list of service providers is further based on a geographic location of the customer relative to geographic locations of service providers in the list of service providers.

4. The system of claim 1, wherein the processor is further configured to generate one or more graphical user interfaces that allow selection of at least one service provider from the list of service providers.

5. A method to facilitate geographical and specialistic auto-locating and communication between a customer and a service provider, the method comprising:
obtaining the customer request from the customer device to perform a predefined task;
identifying a list of service providers based on the customer request, the customer inputs, and the service provider inputs;
transmitting the list of service providers to the customer device;
receiving a selection of a service provider from the list of service providers from the customer device; and
transmitting a notification to a service provider device associated with the selected service provider to facilitate communication between the customer associated with the customer device and the service provider associated with the service provider device.

6. The method of claim 5, wherein the list of service providers includes at least one other customer providing services as a service provider.

7. The method of claim 5, wherein identifying a list of service providers is further based on a geographic location of the customer relative to geographic locations of service providers in the list of service providers.

8. The method of claim 5, the method further comprising:
generating one or more graphical user interfaces that allow selection of at least one service provider from the list of service providers.

9. A computer-readable medium storing instructions for causing a processor to perform a method for facilitating geographical and specialistic auto-locating and communication between a customer and a service provider, the method comprising:
obtaining the customer request from the customer device to perform a predefined task;
identifying a list of service providers based on the customer request, the customer inputs, and the service provider inputs;
transmitting the list of service providers to the customer device;
receiving a selection of a service provider from the list of service providers from the customer device; and
transmitting a notification to a service provider device associated with the selected service provider to facilitate communication between the customer associated with the customer device and the service provider associated with the service provider device.

10. The computer-readable medium of claim 9, wherein the list of service providers includes at least one other customer providing services as a service provider.

11. The computer-readable medium of claim 9, wherein identifying a list of service providers is further based on a geographic location of the customer relative to geographic locations of service providers in the list of service providers.

12. The computer-readable medium of claim 9, the method further comprising:
generating one or more graphical user interfaces that allow selection of at least one service provider from the list of service providers.
